(19) United States
(12) Patent Application Publication
(10) Pub. No.: US 2008/0033793 A1
(43) Pub. Date: Feb. 7, 2008

(54) Method of capturing customer transaction data by routine declining of authorization requests

(76) Inventor: Larry LeMaitre Roberts, Santa Rosa, CA (US)

Correspondence Address: STAINBROOK & STAINBROOK, LLP, 412 AVIATION BOULEVARD, SUITE H, SANTA ROSA, CA, 95403, US

(21) Appl. No.: 11/378,119

(22) Filed: Mar. 16, 2006

Related U.S. Application Data
(63) Continuation-in-part of application No. 11/289,936, filed on Nov. 29, 2005, now abandoned.
Application No. 11/289,936 is a continuation-in-part of application No. 10/620,219, filed on Jul. 14, 2003.
(60) Provisional application No. 60/395,404, filed on Jul. 12, 2002.

(51) Int. Cl. G06Q 30/00

(52) U.S. Cl. 705/14

(57) ABSTRACT

A method of capturing customer transaction data utilizing existing multi-merchant payment network infrastructure. A clearinghouse issues a card containing a financial institution identification number to a customer. The customer can use this card at any point of sale that accepts payment card transactions. Data including the card number, the amount of the sale and the time and date of the transaction is transmitted to the clearinghouse over the existing payment card infrastructure. This data can then be used to provide rebates or bonus points to the customer and/or provide a donation to a non-profit entity of the customer's choice.

### CROSS REFERENCE TO RELATED APPLICATIONS

The present application claims the benefit of U.S. continuation-in-part utility patent application Ser. No. 11/289,936, filed Nov. 29, 2005; U.S. utility patent application Ser. No. 10/620,219, filed Jul. 14, 2003; and U.S. provisional patent application Ser. No. 60/395,404, filed Jul. 12, 2002.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates generally to a method of capturing customer transaction data, more specifically, to a method for capturing customer transaction data through existing multi-merchant payment networks, which provide for credit card, debit card, or prepaid card transactions, by routinely declining authorization requests.

### BACKGROUND INFORMATION AND DISCUSSION OF RELATED ART

In the last several years, many loyalty programs have been developed for rewarding customers for making purchases at retail outlets or for using a particular credit card for making purchases. These include, inter alia, the now familiar programs conducted by supermarkets that give customers discounts on items being purchased; point programs, which give customers points or mileage which can be redeemed for airline travel or other valuable goods or services; rebate programs that provide a cash rebate to the customer; and donation programs, where a donation is made to a particular non-profit entity on behalf of the customer. These programs all require that certain customer transaction data be captured and recorded. At a minimum, this customer transaction data includes data identifying the customer, data indicating a purchase was made, data indicating where the purchase was made and in most situations data identifying the amount of the customer's purchase.

These programs generally fall into two categories: programs which are funded by merchants as an incentive for customers to shop at the merchant that is funding the program, and programs funded by financial institutions or credit companies as an incentive for customers to use a particular credit or debit source for consummating purchases. The programs which are funded by merchants are administered either by the merchant itself using its internal data collection system to capture customer transaction data, or are conducted through clearinghouses, which acquire the customer transaction data for the merchant and then bill the merchant an agreed upon amount for crediting the customer with rewards. A clearinghouse may or may not be a financial institution.

When a clearinghouse is used to administer a program, the clearinghouse acquires the data necessary for billing a merchant for the costs of the rewards and crediting the customer with rewards, by issuing a loyalty card to the customer. When making a purchase, the customer swipes the loyalty card at a point-of-sale (POS) terminal at a participating merchant. The customer transaction data and additional data identifying the merchant are then transmitted to the clearinghouse. In order for the clearinghouse to receive the data from the POS terminal, the terminal must be programmed at the point-of-sale to recognize a card issued by the clearinghouse and, upon recognizing such a card, to dial into the clearinghouse's computer system. This method is referred to by those skilled in the art as “split-dial” since the POS terminal is programmed to dial into the merchant's acquiring bank to process credit card transactions and is also programmed to dial into the clearinghouse's computer system to transmit the transaction data.

The split-dial method for acquiring the data necessary to administer loyalty rewards programs is costly and inefficient. The merchant's POS terminals must be programmed to recognize the specific loyalty card and to dial into the clearinghouse that is administering the program. The costs associated with programming the POS terminals are a deterrent to merchant participation in such programs.

Loyalty programs funded by financial institutions and credit card companies generally do not require the programming of POS terminals in order to administer the programs since the POS terminals are already programmed to consummate a payment card transaction. In these programs the customer transaction data necessary for administering the program is obtained from the payment card transaction data sent from the POS to the issuing financial institution. However, such programs are limited in that the customer is only rewarded for transactions made with a particular credit card, debit card or prepaid card. Transactions consummated with cash, check or other sources of funds are not rewarded.

Therefore, a method for capturing customer transaction data for administering a loyalty, barter or other customer benefits program is desired that captures customer transaction data for a customer transaction regardless of how the transaction is consummated and which does not require the POS terminals to be programmed for split-dial operation.

With the foregoing background discussion in view, it is respectfully submitted that no known prior art document discloses, teaches, suggests, shows, or otherwise renders obvious, either singly or when considered in combination, the invention described and claimed herein.

### BRIEF SUMMARY OF THE INVENTION

To achieve the foregoing and in accordance with the purpose of the present invention, a method of capturing customer transaction data for the administration of a loyalty, barter, or other customer benefits program is disclosed that permits the capture of the customer transaction data independent of the form of payment a customer uses to consummate a transaction and obviates the need for programming POS terminals for split dial operation. The method of this invention utilizes existing multi-merchant payment network infrastructure and authorization systems to deliver customer transaction information to a clearinghouse whether the customer uses cash, a check, a credit card, a debit card, a negotiable instrument, or other form of customary and suitable payment to consummate the transaction. Such multi-merchant payment networks, include, but are not limited to the Visa, MasterCard, Discover, and American Express payment networks which facilitate the consummation of customer transactions when credit cards, debit cards or prepaid cards are used for payment.

The method of the present invention provides numerous advantages and features over the prior art. The elimination of the need to program a POS terminal for split dial operation saves merchants wishing to participate in a loyalty, barter, or other customer benefits program the time and expense of programming the POS terminals to recognize a loyalty card and to dial into a clearinghouse for capturing the customer transaction data. The elimination of the need for split-dial programming also provides additional flexibility, in that merchants can participate in several programs without additional overhead expense.

The method of the present invention further permits any merchant accepting Visa, MasterCard, Discover, American Express or other card which utilizes a multi-merchant payment network for processing credit, debit or prepaid transactions to participate in any program which utilizes this invention. For example, a small retail merchant on the East Coast which accepts MasterCard for payment could participate in a loyalty, barter, or other program administered by a clearinghouse in California, and another program administered by a clearinghouse in Florida without making any changes to its POS terminal.

Merchants will find programs utilizing the method of this invention desirable over the prior art, since the method permits merchants to leverage program benefits with other merchants participating in the same program. As an example, a restaurant may offer loyalty points in a particular loyalty program to a customer based on his purchases at the restaurant. A retail store could also offer points in the same loyalty program to the same customer, based on his purchases in the retail store. Heretofore, such leveraging in loyalty programs has been limited because each merchant participating in a particular program was required to program its POS terminals for split dial operation.

An additional advantage of the present invention is that a merchant may offer varying program benefits for purchases based on the time of the day or the date the transaction is consummated. For instance, a restaurant may offer an increased reward for diners eating at off-peak hours, or a furniture store may offer increased rewards on a special date, such as a holiday.

Another advantage of the present invention is that it permits rewards accumulated by a customer to be awarded to the customer, to a non-profit entity or entities of the customer's choosing, or to both the customer and a non-profit entity or entities. In a preferred embodiment of this invention rewards accumulated by a customer are split with a fraction of the rewards providing for a donation to a charity or non-profit entity at regular intervals while the remaining rewards may be redeemed by the customer for cash, services or items of value.

Another advantage of this invention is that it facilitates the gathering of customer information for use in identifying potential new credit customers. Information regarding a customer's purchases whether made with cash, check, credit card, debit card or other payment source can be used in assessing a potential credit customer's spending patterns and credit-worthiness. (Such payment means contemplate the use of negotiable instruments to consummate consumer transactions, as the term “negotiable instruments” is broadly defined in the Uniform Commercial Code §§ 3-103 and 3-104.) This information is valuable to both the merchant, who may wish to extend credit to a particular customer, and the clearinghouse that may wish to offer a credit-card to the customer.

Other novel features which are characteristic of the invention, as to organization and method or operational steps, together with further objects and advantages thereof will be better understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty that characterize the invention are pointed out with particularity in the claims annexed to and forming part of this disclosure. The invention does not reside in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other methods and systems for carrying out the several purposes of the present invention. It is important, therefore, that the claims be regarded as including such equivalent constructions insofar as they do not depart from the spirit and scope of the present invention.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a schematic block diagram showing a first preferred embodiment of the inventive method of capturing customer transaction data by routine declining of authorization requests, showing the inventive method operatively incorporated into an existing credit/debit card approval process with split-dial operations to a clearinghouse;

FIG. 2 is a schematic block diagram illustrating an alternative existing credit/debit card approval process and an alternative embodiment of the inventive method.

### DETAILED DESCRIPTION OF THE INVENTION

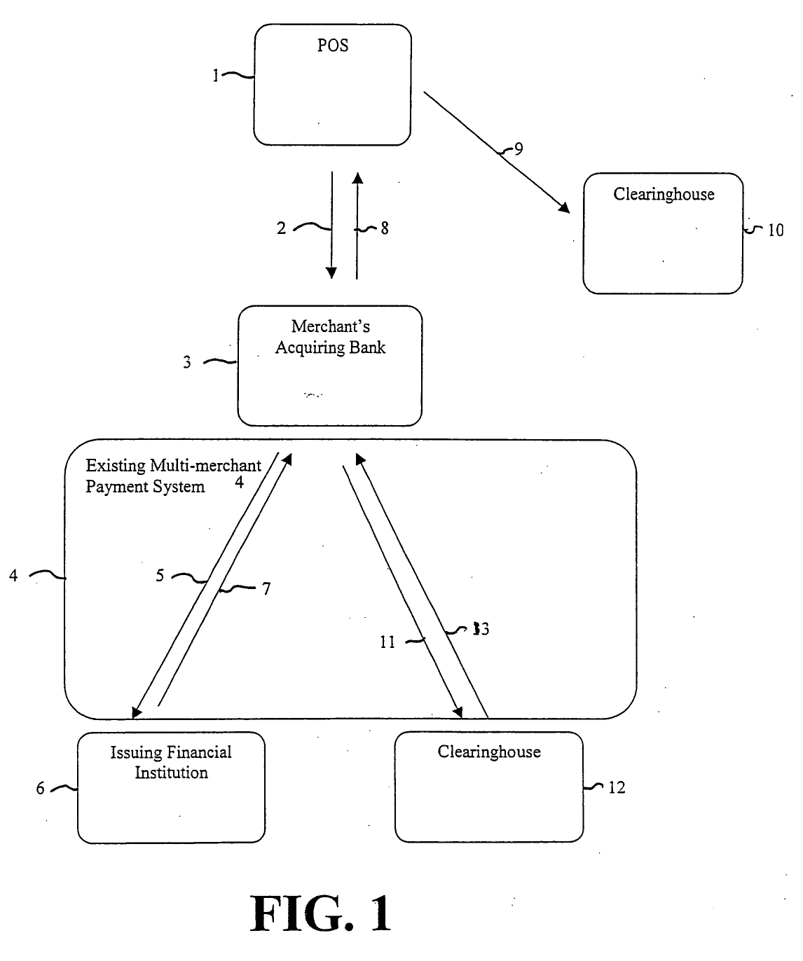

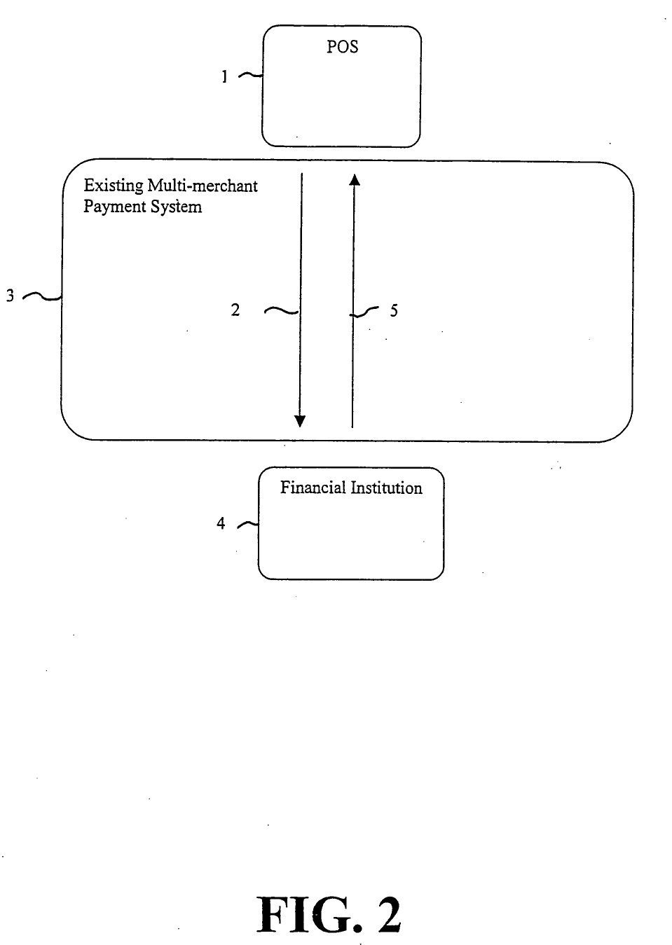

Referring to FIGS. 1 and 2, wherein like reference numerals refer to like components in the various views, there is illustrated therein a new and improved method of capturing customer transaction data by a routine declining of authorization requests.

In a typical Visa or MasterCard credit card or debit card transaction, a merchant calculates the amount of a purchase and asks the customer for payment. The customer then presents the merchant with a payment card that provides access to the particular source of funds the buyer would like to use to make the purchase. The payment card is then run through a POS terminal 1 with the amount of the sale entered either manually or automatically by a cash register. A transaction data packet is then transmitted 2 to the merchant's acquiring bank 3. The transaction data packet comprises data, including: a merchant's identification number, the merchants “doing-business-as” name, the merchant's street address, the merchant's city, the merchant's zip code, the merchant's state, the merchant's country, the merchant's classification code, the transaction amount, the net transaction count, the credit card or debit card number and the transaction date.

The merchant's acquiring bank 3 then identifies the financial institution that issued the buyer's payment card through a Bank Identification Number (BIN) contained in the credit card or debit card number and routes 5 an authorization request through the existing payment card network infrastructure 4 to an issuing processor associated with the issuing financial institution 6. If the cardholder has sufficient credit or funds to cover the transaction, the issuing processor authorizes the transaction, generates an authorization code and puts a hold on the cardholder's account for the amount of the transaction. If the cardholder does not have sufficient funds or credit, the issuing financial institution generates a declining code. The issuing financial institution 6 sends 7 the authorization or declining code to the merchant's acquiring bank 3 through the existing payment card network infrastructure 4. The merchant's acquiring bank, in turn, transmits 8 the authorization or declining code to the merchant's POS terminal 1. If the issuing financial institution 6 transmitted a declining code, the cardholder must present another form of payment, e.g. cash, traveler's checks, or other credit or debit cards which access different funds in order to complete the transaction.

In a merchant funded loyalty program, the POS terminal 1 is programmed to recognize a loyalty card issued by the merchant or clearinghouse. The POS terminal is also programmed to dial into a clearinghouse 10 in order to transfer data necessary for administering the loyalty reward program. To capture customer transaction data for a particular transaction, the loyalty card is swiped in the POS terminal 1. The terminal recognizes the loyalty card as one accepted by the merchant. The POS terminal dials into the clearinghouse 9 and then transmits the data necessary for administering the loyalty program to the clearinghouse 10. Once the data is transmitted, the POS terminal 1 disconnects from the clearinghouse 10.

Thus it is known in the art that customer transaction data can be transmitted to a clearinghouse using a direct connection to the clearinghouse. It is also known that customer transaction data can be transmitted over the existing payment card network infrastructure to a financial institution that issued a credit or debit card when that particular credit card or debit card is used to consummate a transaction. It is also known that issuing financial institutions use the customer transaction data to provide loyalty rewards and other incentives to customers. This is common in the industry where an issuing financial institution provides a payment card to a customer, which permits the customer to receive points or miles on an airline's frequent flyer program. The issuing financial institution captures the customer transaction data when the payment card is used to consummate the customer transaction and awards the points or miles based on the customer transaction data. A fundamental limitation of this method of acquiring customer transaction data is that the customer transaction information is captured only when the customer uses the credit card or debit card issued by the issuing financial institution to consummate the customer transaction. If the customer does not use the credit card or debit card issued by the financial institution to consummate the transaction, or if the issuing financial institution declines the transaction, the customer does not receive a reward, even if the sale is consummated using another form of payment.

The present invention overcomes the limitations of the prior art and provides a method for capturing customer transaction information over the existing payment card network infrastructure which permits the capture of customer transaction data regardless of the form of payment used to consummate the transaction and without the necessity of programming POS terminals for split-dial operation.

The method of this invention utilizes the existing credit card authorization infrastructure as described above, to capture customer transaction information at a clearinghouse for administering a customer benefits program. Referring again to FIG. 1. In the present invention, a clearinghouse issues the customer a program card which has a unique card number containing a Bank Identification Number (BIN) associated with the clearinghouse. When a customer makes a purchase at a participating merchant, data from the program card is entered into a POS terminal 1. In a preferred embodiment of this invention, the data from the card is entered into the terminal via a magnetic strip on the back of the program card, which is read by the POS terminal 1 when the card is swiped through the terminal. A data packet is transmitted 2 by the POS terminal 1 to the merchant's acquiring bank 3. The merchant's acquiring bank 3 then identifies the clearinghouse processor associated with the clearinghouse 12 that issued the program card through the Bank Identification Number (BIN) contained in the program card number. An authorization request is routed 11 through the existing payment card network infrastructure 4 to the clearinghouse 12. The clearinghouse processor 12 records the customer transaction data, for use in administering the program and issues a declining code, sending 13 the declining code to the merchant's acquiring bank 3 through the existing payment card network infrastructure 4. The merchant's acquiring bank 3, in turn, transmits 8 the declining code to the merchant's POS terminal 1. Since a declining code is received by the merchant's POS terminal, the transaction is not consummated and the program cardholder presents another form of payment, e.g. cash, traveler's checks, or other credit or debit cards which access different funds in order to consummate the transaction.

In a preferred embodiment of this invention the data packet includes information identifying the time of the transaction and the items or services purchased by the customer. The time of the transaction may be used in administering the program by permitting merchants to offer variable benefits depending on the time of the transaction. Information regarding the services or items purchased can be collected, collated and provided to participating merchants to assist them in accounting and inventory auditing.

An important feature of another embodiment of this invention is that a stand-in limit of $0 is applied to each transaction. A stand-in limit is known to those of skill in that art as pre-arranged dollar limits which permit a merchant's acquiring bank to send an authorization code to a POS terminal if no authorization or declining code is received in a specified period of time as long as the transaction amount is below the pre-arranged dollar limit. The stand-in-limits facilitate the approval of relatively small transactions when heavy traffic, service, or malfunction prevents the existing payment card infrastructure or the issuing processor from issuing a timely authorization code or declining code. In this case customer transaction data is retained by the merchant's acquiring bank and transferred to the issuing financial institution during a settlement process some time thereafter. A maximum stand-in-limit is pre-arranged by the issuing financial institution, because the issuing financial institution assumes the risk that the customer has sufficient credit or funds to cover the transaction.

As stated before, it is an important feature to this invention that a stand-in-limit of $0 is applied to each transaction. Therefore if no approval or decline code is received by the merchant's acquiring bank within a specified period of time, the merchant's acquiring bank will send a decline code to the POS terminal. The customer transaction data from such a transaction will be then transmitted to the clearinghouse during the settlement process.

A separate embodiment of this invention is used to capture customer transaction data on a closed loop multi-merchant payment network. In a typical closed loop multi-merchant payment network, customer transactions are consummated using a credit card, a debit card, or a prepaid card. Referring now to FIG. 2. In a closed loop multi-merchant payment network a credit card, a debit card, or a prepaid card associated with a particular program is swiped at the POS terminal (1). The POS terminal recognizes the card as one associated with the particular financial institution and transmits 2 a transaction data packet directly to a processor associated with the particular financial institution 4 over an existing multi-merchant payment network 3. If the customer presenting the card has sufficient credit or funds to cover the transaction, the processor associated with the financial institution authorizes the transaction, generates an authorization code and puts a hold on the cardholder's account for the amount of the transaction. If the cardholder does not have sufficient funds or credit, the processor associated with the financial institution generates a declining code. The financial institution 4 sends 5 the authorization or declining code directly back to the POS 1 over the multi-merchant payment network 3. If the financial institution 4 transmitted a declining code, the cardholder must present another form of payment, e.g. cash, traveler's checks, or other credit or debit cards which access different funds in order to complete the transaction.

Using an embodiment of this invention, customer transaction data can be captured using a non-payment card by issuing a customer a program card which has a unique card number which is associated with a particular financial institution. When a customer makes a purchase at a participating merchant, data from the program card is entered into a POS terminal 1. In a preferred embodiment of this invention, the data from the card is entered into the terminal via a magnetic strip on the back of the program card, which is read by the POS terminal 1 when the card is swiped through the terminal. The POS terminal recognizes the card as one associated with the particular financial institution and transmits 2 a transaction data packet directly to a processor associated with the particular financial institution 4 over an existing multi-merchant payment network 3. The processor associated with the particular financial institution 4 then records the customer transaction data and issues a declining code. The financial institution 4 sends 5 the declining code directly back to the POS over the multi-merchant payment network 3. The customer then presents another form of payment, e.g. cash, a traveler's check, credit card or debit card to consummate the transaction.

It will be appreciated in yet another aspect beyond the previously described program applications, the inventive system could be employed to track and record transactions in the context of bartering and any other transactions, whether at the retail or wholesale level, that are tracked and recorded, regardless of type of input device, such as a magnetic strip card, a chip card, a key fob, or other account identifying device, using established payment networks that provide any messaging at the point of sale that does not authorize payment. All of which illustrate that this further aspect is a logical and practical extension of the above-described system.

Thus, it will be appreciated that in its most essential aspect, the inventive method is a method of capturing data from a customer transaction with a merchant for administering a customer benefits program comprising the steps of: (a) issuing a program card with a unique card number to a customer, said card number comprising a Bank Identification Number; (b) transmitting a data packet from a POS terminal to the merchant's acquiring bank, the data packet including the unique card number, data identifying the merchant, and data identifying the dollar amount of the customer transaction; (c) transmitting an authorization request over the existing payment card authorization infrastructure to a clearinghouse; (d) recording customer transaction data at the clearinghouse; (e) transmitting a declining code to the merchant's acquiring bank over the existing credit card infrastructure; and, (f) transmitting a declining code through the merchant's acquiring bank to the POS terminal.

The reader will see that the method of acquiring customer transaction data for a customer benefits program of this invention provides many advantages over the prior art. These advantages include increased incentive for merchant participation in loyalty, barter or other programs, increased incentives for clearinghouses and financial institutions to participate in such programs and increased incentives for customers to participate in the programs.

The foregoing disclosure is sufficient to enable those with skill in the relevant art to practice the invention without undue experimentation. The disclosure further provides the best mode of practicing the invention now contemplated by the inventor.

While the particular method herein shown and disclosed in detail is fully capable of attaining the objects and providing the advantages stated herein, it is to be understood that it is merely illustrative of the presently preferred embodiment of the invention and that no limitations are intended concerning the detail of construction or design shown other than as defined in the appended claims. Accordingly, the proper scope of the present invention should be determined only by the broadest interpretation of the appended claims so as to encompass obvious modifications as well as all relationships equivalent to those illustrated in the drawings and described in the specification.

What is claimed as invention is:

1. A method of capturing data from a customer transaction with a merchant for administering a customer benefits program comprising the steps of:
(a) issuing a program card with a unique card number to a customer, said card number comprising a Bank Identification Number;
(b) transmitting a data packet from a POS terminal to the merchant's acquiring bank, the data packet including the unique card number, data identifying the merchant, and data identifying the dollar amount of the customer transaction;
(c) transmitting an authorization request over the existing payment card authorization infrastructure to a clearinghouse;
(d) recording customer transaction data at the clearinghouse;
(e) transmitting a declining code to the merchant's acquiring bank over the existing credit card infrastructure; and,
(f) transmitting a declining code through the merchant's acquiring bank to the POS terminal.

2. The method of claim 1 further comprising the step of pre-arranging a stand-in-limit of zero dollars.

3. The method of claim 2 wherein the data packet further includes data identifying a time and a date the data packet was transmitted to the acquiring bank.

4. The method of claim 3, wherein the benefits program rewards are variably awarded based on the time and date the data packet is transmitted.

5. The method of claim 2, wherein the clearinghouse administers a customer benefits program with more than one merchant participating in the customer benefits program.

6. The method of claim 5, further including the step of dispersing accrued rewards from the customer benefits program to both a customer that accumulated the rewards and to a non-profit entity.

7. The method of claim 2, further comprising the step of using a cash payment to consummate the customer transaction with the merchant.

8. The method of claim 2, further comprising the step of using a negotiable instrument to consummate the customer transaction with the merchant.

9. The method of claim 2, further including the step of using a debit card to consummate the customer transaction with the merchant.

10. The method of claim 2, further including the step of using a prepaid card to consummate the customer transaction with the merchant.

11. A method of capturing data from a customer transaction with a merchant for administering a benefits program, comprising the steps of:
(a) issuing a program card with a unique card number to a customer, the card number bearing a unique number identifying a financial institution;
(b) transmitting a data packet from a POS terminal to a processor associated with the financial institution, the data packet including the unique card number, data identifying the merchant, and data identifying the dollar amount of the customer transaction;
(c) recording customer transaction data at the processor associated with the financial institution; and
(d) transmitting a declining code to the POS terminal.

12. The method of claim 11, wherein the data packet further includes data identifying a time and a date the data packet was transmitted to the acquiring bank.

13. The method of claim 11 wherein the financial institution administers a benefits program with more than one merchant participating in said program.

14. The method of claim 11, further including the step of dispersing accrued benefits under the program to both a customer that accumulated the benefits and/or a non-profit entity.

15. The method of claim 11, further including the step of using a cash payment to consummate the customer transaction with the merchant.

16. The method of claim 11, further including the step of using a negotiable instrument to consummate the customer transaction with the merchant.

17. The method of claim 11 wherein the program rewards are variably awarded based on the time and date the data packet is transmitted.

18. The method of claim 11, further including the step of using a prepaid card to consummate the customer transaction with the merchant.

19. The method of claim 11, further including the step of using a debit card to consummate the customer transaction with the merchant.

20. The method of claim 11 wherein the customer transaction is consummated by payment to the merchant with a credit card.
